(19) United States
(12) Patent Application Publication
(10) Pub. No.: US 2014/0295831 A1
(43) Pub. Date: Oct. 2, 2014

(54) Background Paging Monitoring in Dual SIM Wireless Communication Device

(71) Applicant: BROADCOM CORPORATION, Irvine, CA (US)

(72) Inventors: Navin KARRA, Bracknell (GB); Yongqian WANG, East Brunswick, NJ (US); Lianghua YANG, Campbell, CA (US); Shiwen CHEN, Morganville, NJ (US); Naveen Reddy PALLE VENKATA, Aberdeen, NJ (US); Yuan LIU, Holmdel, NJ (US); Jun LIN, Cupertino, CA (US); Yaxin CAO, Laurence Harbor, NJ (US); Augustine SHUTON, San Diego, CA (US); Balaji ANANDAPADMANABAN, Bracknell (GB)

(73) Assignee: Broadcom Corporation, Irvine, CA (US)

(21) Appl. No.: 13/853,747

(22) Filed: Mar. 29, 2013

(51) Int. Cl. H04W 68/00

(52) U.S. Cl. CPC H04W 68/005
USPC 455/434

(57) ABSTRACT

A wireless communication device includes a single baseband processor and RF chain for servicing a first and second SIM. Each of the SIMs connects to a different network, and one may be used for one data type while the other is used for another data type. In order to track the connectivity of an inactive first SIM, a controller periodically interrupts service to the second SIM. During its connection, the first SIM monitors the connection to its network. A triggering mechanism and trigger threshold define when a switch to a new cell is needed. The device receives the mechanism and threshold from the network and calculates a modified threshold and/or mechanism is order to reduce a number of potentially missed calls.

### BACKGROUND

1. Field of Invention

The disclosure relates to wireless communications, and specifically to a wireless communication device capable of reducing missed calls as a result of performing background paging monitoring in a wireless communication environment.

2. Related Art

Many modern cellular networks can be connected to through the use of a SIM card. The SIM card is installed into a connection port on a mobile device, and data on the SIM card is utilized by the device for authentication and connection with a particular cellular network.

In some situations, a mobile device may be provided with multiple SIM connection ports for accepting multiple SIM cards. This allows the device user to connect the multiple different networks, often for different data needs. For example, a user may use a first SIM card to connect to a first cellular network, which the user primarily uses for circuit-switched data, such as voice and SMS services. The user may then use a second SIM card to connect to a second cellular network, which the user primarily uses for packet-switched data, such as internet connectivity and streaming services.

### BRIEF DESCRIPTION OF THE DRAWINGS/FIGURES

Embodiments are described with reference to the accompanying drawings. In the drawings, like reference numbers indicate identical or functionally similar elements. Additionally, the left most digit(s) of a reference number identifies the drawing in which the reference number first appears.

FIG. 1 illustrates a block diagram of an exemplary wireless communication environment;

FIG. 2A illustrates a block diagram of an exemplary wireless communication device that may be used within the wireless communication environment;

FIG. 2B illustrates a block diagram of an exemplary first SIM module that may be used within the wireless communication device;

FIG. 3 illustrates a graphical representation of an exemplary cell triggering mechanism that may be used by the wireless communication device;

FIG. 4 illustrates a process flow diagram of an exemplary cell switching process;

FIG. 5 illustrates a flowchart diagram of an exemplary exchange process that may occur during cell selection;

FIG. 6 illustrates a flowchart diagram of an exemplary cell switching triggering method; and

FIG. 7 illustrates a block diagram of an exemplary general purpose computer system.

### DETAILED DESCRIPTION OF THE INVENTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the invention. Rather, the scope of the invention is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer, as described below.

For purposes of this discussion, the term “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

Those skilled in the relevant art(s) will recognize that this description may be applicable to many various communication methods without departing from the spirit and scope of the present disclosure.

### An Exemplary Wireless Communication Environment

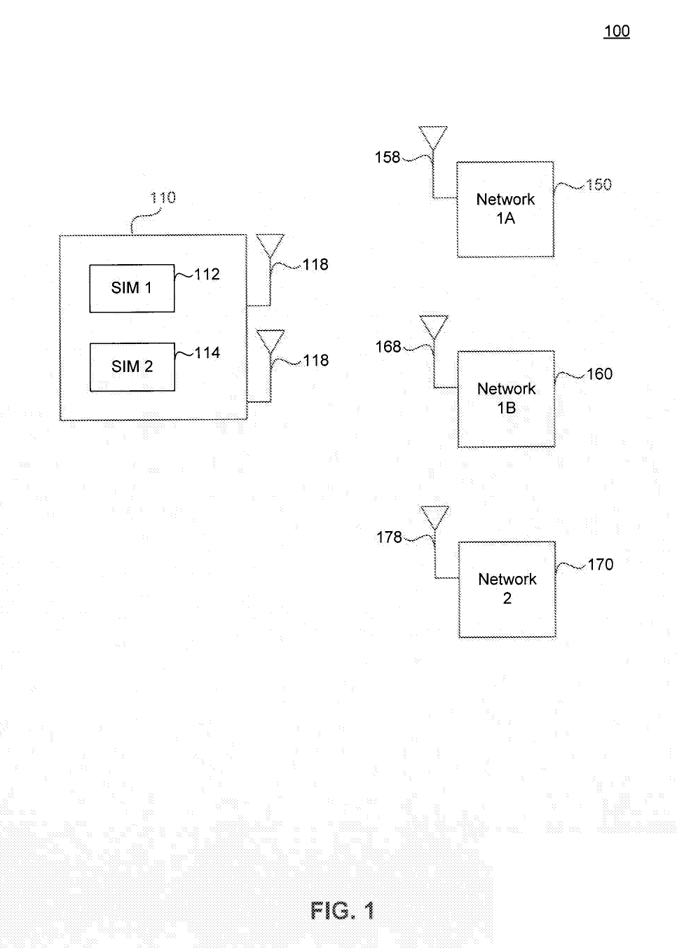

FIG. 1 illustrates a block diagram of an exemplary wireless communication environment 100. The wireless communication environment 100 includes a dual-SIM wireless communication device 110, first network wireless communication devices 150 and 160, and a second network wireless communication device 170.

In the wireless communication environment 100, the dual-SIM wireless communication device 100 communicates with one or more of the network wireless communication devices 150/160/170. The dual-SIM wireless communication device 110 includes a first SIM module 112 and a second SIM module 114 and communicates via one or more antennas 118. In an embodiment, the dual-SIM wireless communication device 110 is a mobile device.

First network wireless communication devices 150 and 160 are capable of providing cellular communication service to the dual-SIM wireless communication device 110 over a first communication network. The first SIM of the dual-SIM wireless communication device 110 will be used to authenticate and communicate with the first network wireless communication devices 150 and 160. In an embodiment, the first network wireless communication devices 150 and 160 are cellular base stations.

A second network wireless communication device 170 is capable of providing cellular communication service to the dual-SIM wireless communication device 110 over a second communication network. The second SIM of the dual-SIM wireless communication device 110 will be used to authenticate and communicate with the second network wireless communication device 170. In an embodiment, the second network wireless communication device 170 is a cellular base station.

Each of the first network wireless communication devices 150 and 160, and the second network wireless communication device 170, communicate with the due-SIM wireless communication device 110 using one or more antennas 158, 168 and 178, respectively.

### Exemplary Dual-SIM Wireless Communication Device

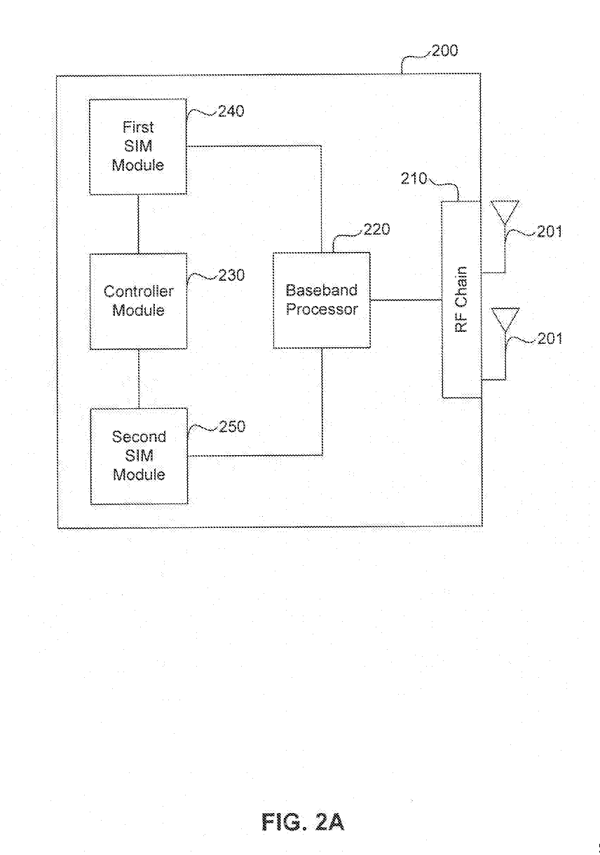

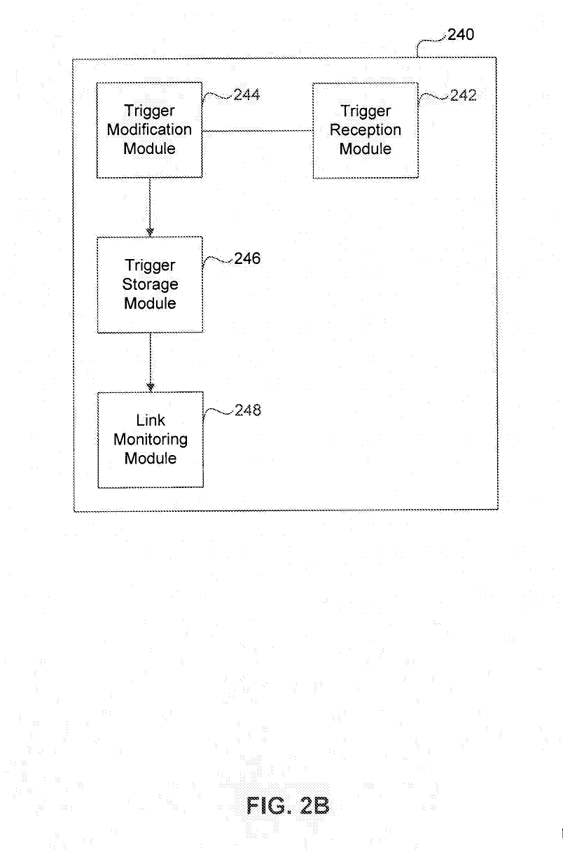

FIG. 2A illustrates a block diagram of an exemplary wireless communication device 200 that may be used within the wireless communication environment 100. The wireless communication device 200 includes a first SIM module 240, a second SIM module 250, and a controller module 230, and may represent an exemplary embodiment of the wireless communication device 110. The first and second SIM modules 240/250 can represent at least a portion of first and second SIM cards that include at least some features according to embodiments of the present disclosure.

As shown in FIG. 2A, the wireless communication device 200 includes a single baseband processor 220 and RF chain 210. The RF chain 210 receives wireless signals from a base station in the environment 100 depending on which SIM is currently active, and may include one or more filters, amplifiers, mixers, local oscillator, etc. The baseband processor 220 includes necessary circuitry for managing the RF chain 210 and signals received thereby. For example, the baseband processor 220 may include one or more of filters, amplifiers, local oscillators, PLLs, demodulators, D/A converters, etc. The baseband processor 220 receives the signals from the RF chain 210 that originated from the environment 100, and processes those signals to be useable by the components of the wireless communication device 200.

When the first SIM module 240 is active, the RF chain 210 receives signals from a first network basestation. On the other hand, when the second SIM module 250 is active, the RF chain 210 receives signals from a second network basestation. In an embodiment, and for purposes of the discussion below, the first SIM module 240 is associated with circuit-switched data, such as voice and text data, whereas the second SIM module 250 is associated with packet-switched data, such as internet or streaming data.

In conventional dual-SIM devices, only one SIM can be active at any time due to the single RF chain 210 and baseband processor 220. This can result in some significant issues. For example, one particularly important problem with conventional dual-SIM mobile devices is that, when the user is using the packet-switched network, incoming phone calls cannot be received. This is obviously undesired. Therefore, a controller module 230 of the exemplary dual-SIM device 200 of FIG. 2A coordinates background paging monitoring between the first SIM module 240 and the second SIM module 250. In addition, the first SIM module 240 calculates and employs a modified cell switch trigger in order to significantly reduce a number of missed calls.

Coordinated Background Paging Monitoring

As the dual-SIM wireless communication device 200 moves within the environment 100, the device 200 may move in and out of service of various first SIM serving cells. However, if the device 200 is utilizing packet-switched data on the second SIM, the device 200 will be unable to determine whether calls are being received on the first SIM and/or whether the previous serving cell has been maintained/lost. Therefore, the controller module 230 coordinates background paging monitoring between the first and second SIMs. For purposes of the following description, it is to be assumed that the second SIM module 250 is the primary active SIM, and that the first SIM 240 is primarily inactive.

The device 200 begins in a packet-switched data mode. In this mode, the controller module 230 controls the second SIM module 250 to be active, and therefore also controls the RF chain 210 and the baseband processor 220 to receive and process packet-switched data using the authentication/connection defined by the second SIM module 250.

After the device 200 has been in the packet-switched data mode for a predetermined time interval, the controller module 230 temporarily suspends the second SIM module 250 and its data reception. During a brief second predetermined time interval, the controller module 230 causes the first SIM to become active, and therefore controls the RF chain 210 and the baseband processor 220 to receive/process signals using the authentication/connection defined by the first SIM module 240. In an embodiment, the second time interval is shorter in duration than the first time interval.

During the second time interval, the device 200 is in a circuit-switched mode, in which the device 200 is capable of receiving and processing any incoming paging blocks indicative of whether there is currently an incoming phone call. If the second time interval is sufficiently long, the device 200 can also seek out and measure neighboring cells. In particular, in order to perform a future cell switch, it is important to measure signal properties of nearby cells in order to switch to a viable cell.

If, during the second time interval, the first SIM module 240 processes a paging block that indicates the presence of an incoming call, the first SIM module 240 notifies the controller module 230. The controller module 230 then maintains the device 200 in the circuit-switched mode, in which the second SIM module 250 remains inactive and the first SIM module 240 remains active. The call is then received and processed by the first SIM module 240.

If the paging blocks indicate that there are no incoming calls (or once the call has been terminated and the user has reinitiated packet-switched data calls), the controller module 230 suspends the circuit-switched mode and reactivates the packet-switched data mode. In other words, the controller module 230 suspends the first SIM module 240 and service to the first SIM module 240 by the RF chain 210 and the baseband processor 220. In addition, the controller module 230 activates the second SIM module 250 and initiates second SIM service by the RF chain 210 and the baseband processor 220.

In an embodiment, the second SIM module 250 may include a buffer or storage module (not shown). While the second SIM module 250 is active, the second SIM module 250 can fill its buffer module with received data. When the controller module 230 suspends service to the second SIM module 250, the device 200 can continue to provide packet-switched service to the user by retrieving stored data from the buffer module in the second SIM module 250.

By utilizing this background paging monitoring configuration, regardless of whether the second SIM module 250 includes a buffer module, the device 200 can periodically monitor for incoming calls without causing noticeable interruption to packet-switched data services. As such, the user of the device 200 can enjoy packet-switched data services without forfeiting their ability to receive incoming voice calls.

Triggering Serving Cell Switch

During the background paging monitoring, discussed above, in order to maintain connectivity with the first SIM network, it is necessary to monitor the first SIM serving cell and trigger a switch of the serving cell when necessary. In other words, the device 200 must determine when the current serving cell servicing the first SIM module 240 is no longer viable and seek out and switch to an alternative first SIM cell in order to maintain network connectivity on the first SIM network.

FIG. 2B illustrates a block diagram of an exemplary first SIM module 240 that may be used within the wireless communication device 200. The first SIM module 240 includes a trigger reception module 242, a trigger modification module 244, a trigger storage module 246 (e.g. RAM or ROM or other storage device), and a link monitoring module 248.

Different radio access technologies (RATs) will utilize different triggering mechanisms. For example, 3G monitors a duration of low signal strength and 2G tracks failed paging block decoding attempts. Other RATs may employ other triggering mechanisms, all of which can be supported by the first SIM module 240.

During an active period of the first SIM module, the trigger reception module 242 acquires a triggering mechanism and/or trigger threshold value from a serving base station. A triggering mechanism may be a method or algorithm for determining whether the trigger threshold value has been met, and the trigger threshold value may be associated with the mechanism and represent a need to switch serving cells. In an embodiment, the trigger reception module 242 acquires the triggering mechanism and/or trigger threshold value from memory within the wireless communication device 200 based on an RAT of the serving basestation. Once acquired, the trigger modification module 244 receives the triggering mechanism and/or trigger threshold value and calculates a new mechanism and/or value based on the original, discussed in further detail below.

The modified triggering mechanism and modified trigger threshold value are stored in the trigger storage module 246 (an original mechanism is stored if the mechanism was not modified, and an original threshold value is stored if the threshold value was not modified). The link monitoring module 248 monitors performance of a current link to the serving cell and performs the triggering mechanism stored in the trigger storage module 246. Once the link monitoring module 248 determines that the stored trigger threshold value has been met using the stored triggering mechanism, the link monitoring module 248 notifies the controller module 230, which initiates a switch of the serving cell in the manner described above. Examples of detecting whether the trigger has been met will now be provided.

As discussed above, during background paging monitoring, it may be possible to seek out and measure neighboring cells for possibly providing future service. In an embodiment, although the triggering mechanisms are running in the background, a determination of whether their thresholds have been met is only made once a neighboring cell is discovered that is a predetermined threshold stronger than the serving cell. For example, the triggering mechanism may only be checked once a neighboring cell is found that is 3 dB stronger than the serving cell.

### 2G Example

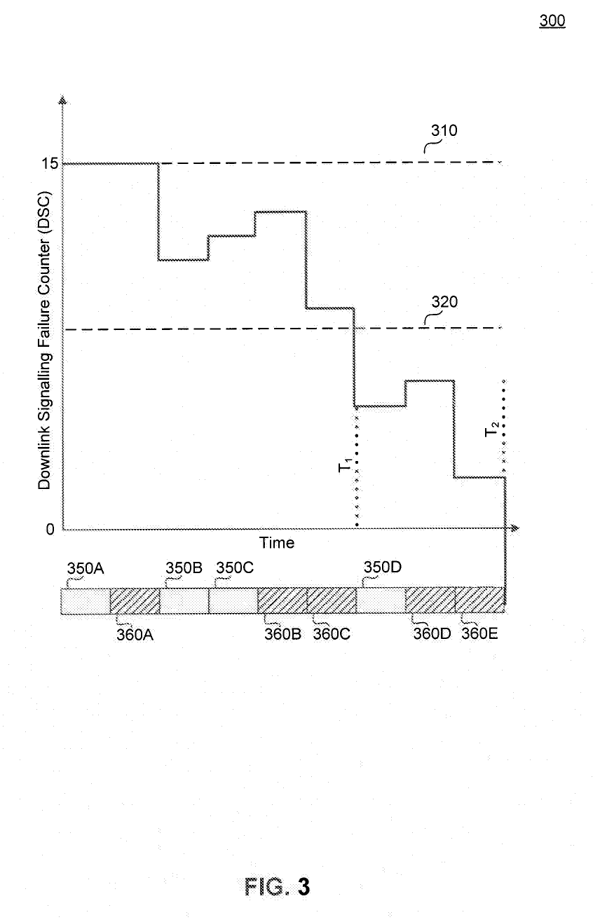

FIG. 3 illustrates a graphical representation of an exemplary cell triggering mechanism that may be used by the wireless communication device 200 in accordance with a 2G RAT example. In this 2G RAT example, the trigger reception module 242 acquires both a triggering mechanism and a trigger threshold value from a serving basestation. The defined mechanism provides an initial value (e.g., 15) and dictates that each paging block decoding success will increase a current value by one (1) up to the initial value, whereas each paging block decoding failure will reduce a current value by four (4) down to a predefined minimum of zero (0). The trigger reception module 242 also acquires a trigger threshold value of zero (0). Thus, using this defined triggering mechanism, a serving cell switch will be initiated when the algorithm produces a value equal to the trigger threshold value (0).

The trigger reception module 242 forwards the above triggering mechanism and trigger threshold value information to the trigger modification module 244, which then calculates at least one of a modified triggering mechanism and a modified trigger threshold value. In this example, the trigger modification module 244 calculates a modified trigger threshold value equal to a midpoint between the original threshold (0) and the initial value (15)=8 (after rounding). In an embodiment, the modified mechanism/threshold are calculated such that the cell switch is initiated earlier than in the original mechanism/threshold. This allows for earlier detection of “loss of serving cell,” which initiates a cell switch at an earlier time. Consequently, fewer calls are lost. In an embodiment, the modified mechanism/threshold are carefully calculated to provide a balance between reducing missed calls and conserving battery life/minimizing packet-switched data interruptions. In an embodiment, using the midpoint between the original threshold value and the initial value was found to satisfy this balance.

As shown in the example of FIG. 3, an initial value is set to 15, as instructed by the triggering mechanism. A first paging block 350A is successfully decoded, which does not raise the current value because it is already at the maximum value. Decoding of the subsequent paging block 360A fails, and therefore reduces the current value by four (15−4=11). Two subsequent successful paging blocks 350B and 350C each raise the current value by one (11+1+1=13). Decoding of two subsequent paging blocks 360B and 360C each fail, reducing the current value by eight (13−4−4=5). At this time, using the modified threshold value calculated by the trigger modification module 244, the threshold value has been met. Consequently, the link monitoring module 248 notifies the controller module 230, and a cell switch is initiated.

As can be seen from FIG. 3, the original threshold value would only have been after three subsequent paging blocks were decoded. This delay increases the likelihood of missing incoming call attempts due to lack of service by the serving cell.

As noted above, the trigger modification module 244 could have calculated a modified triggering mechanism. For example, the trigger modification module 244 could have kept a threshold value equal to zero (0), and instead determined that paging block decoding failures reduce a current value by eight (8). Using the example in FIG. 3, paging blocks 350A, 360A, 350B, 350C, 360B, and 360C would have produced values equal to 15, 7, 8, 9, 1, and 0, respectively. Therefore, the threshold value would have been met at the same time as in the above example. Other mechanisms, threshold values, or combinations thereof could have been calculated to reduce a cell switch triggering time.

### 3G Example

In a 3G example, the trigger reception module 242 determines that the serving cell uses a 3G RAT, and therefore retrieves a corresponding triggering mechanism and trigger threshold value from memory. The triggering mechanism indicates that the signal strength of signals received from the serving cell must fall below a predetermined signal strength for a predetermined threshold value of time in order to dictate the need for a cell switch. The corresponding threshold value of time is defined as 12 seconds, for an example.

The trigger modification module 244 receives this information from the trigger reception module 242 and calculates a modified threshold value of time, for example, a reduced number of seconds, such as 2 seconds (as compared to the conventional 12). This information is stored in the trigger storage module 246. The link monitoring module 248 then monitors signal strength of signals received from the serving cell. Once the signal strength falls below the predetermined signal strength, the link monitoring module 248 begins a time counter. If the signal strength exceeds the predetermined signal strength before the counter reaches 2 seconds, the trigger is not met and the clock stops. On the other hand, if the signal strength remains below the predetermined signal strength for longer than the trigger threshold time value of 2 seconds, then the link monitoring module 248 notifies the controller module 230 to initiate a switch.

In another example, the trigger modification module 244 generates a modified trigger mechanism in which the signal strength level is set to a value higher than the predetermined signal strength. Using either of these examples, a cell switch is triggered earlier than it would have using the original mechanism/threshold. Therefore, fewer calling attempts are missed.

Switching Cells

Once the trigger threshold has been met, and the controller module 230 has been notified of the need to switch serving cells, the controller module 230 can initiate a cell switch. Because of the dual-SIM configuration, the controller module 230 must suspend service to the second (packet-switched data) SIM. Once the second SIM module 250 has had its service suspended, the controller module 230 then activates the first SIM module 240.

Once the first SIM module 240 has been activated, the controller module 230 performs a cell switch. In particular, the first SIM module 240 begins by scanning for and measuring neighboring cells. If the first SIM module 240 had been previously able to measure neighboring cells, then this step is not needed. Once measured, the first SIM module 240 acquires a neighboring cell (ncell) list. The first SIM module 240 organizes this list (e.g., by signal strength) and attempts to connect to a first ncell in the list, e.g. the one with the highest signal strength. If the connection fails, the first SIM module 240 proceeds to the next ncell in the list until a successful connection is made.

Once the first SIM module 240 has established a new connection with a new serving cell, the controller module reinitiates the background paging monitoring. Specifically, the controller module suspends active service to the first SIM module 240 and activates service to the second SIM module 250.

Background paging monitoring then proceeds in the manner previously described, with the first SIM module decoding paging blocks received from its new serving cell. In an embodiment, the background paging monitoring is only reinitiated once a user reinitiates packet-switched data. Further details regarding the cell switching process will be described below.

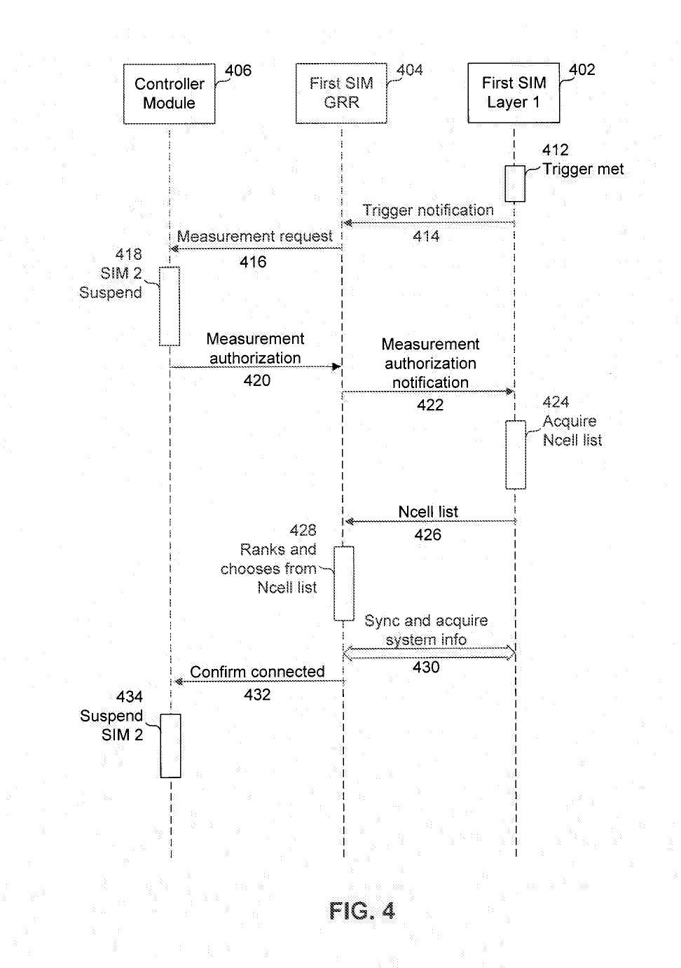

FIG. 4 illustrates a process flow diagram of an exemplary cell switching process that may be carried out by the wireless communication device 200. This process will be discussed with repeated reference to the components illustrated in FIG. 2A.

The cell switching process primarily involves a physical layer 402 of the first SIM module 240, a third layer 404 (e.g., network layer) of the first SIM module 240, and a controller 406 (which may function as a virtual modem controller, and which may be represented by the controller module 230).

Initially, the physical layer determines that the switch trigger has occurred (412). The physical layer 402 sends a trigger notification signal 414 to the third layer 404. The third layer then sends a measurement request 416 to the controller 406. The controller 406 suspends service (418) to the second SIM module 250. Once service has been suspended to the second SIM module 250, the controller 406 sends a measurement authorization signal 420 to the third layer 404, which forwards a measurement authorization notification 422 to the physical layer 402.

Upon receipt of the measurement authorization notification 422, the physical layer 402 seeks out and measures neighboring cells (ncells) in order to acquire an ncell list (424). The physical layer 402 then transmits the ncell list 426 to the third layer 404.

The third layer 404 ranks and selects the ncells in the ncell list. In an embodiment, the third layer 404 ranks the ncells based on received signal strength. In an embodiment, the third layer 404 selects an ncell at the top of the list.

An exchange then occurs 430 between the third layer 404 and the physical layer 402 in order to attempt to sync to the selected ncell and acquire its system information. The sync and system information acquisition are attempted by the physical layer 402 and reported to the third layer 404. If either the sync or the system information acquisition fails, the physical layer 402 reports the failure to the third layer 404. The third layer then selects a subsequent ncell from the list, and the physical layer 402 attempts to sync to that ncell and acquire its system information. This repeats until a suitable ncell is selected and synced to, and its system information is successfully acquired.

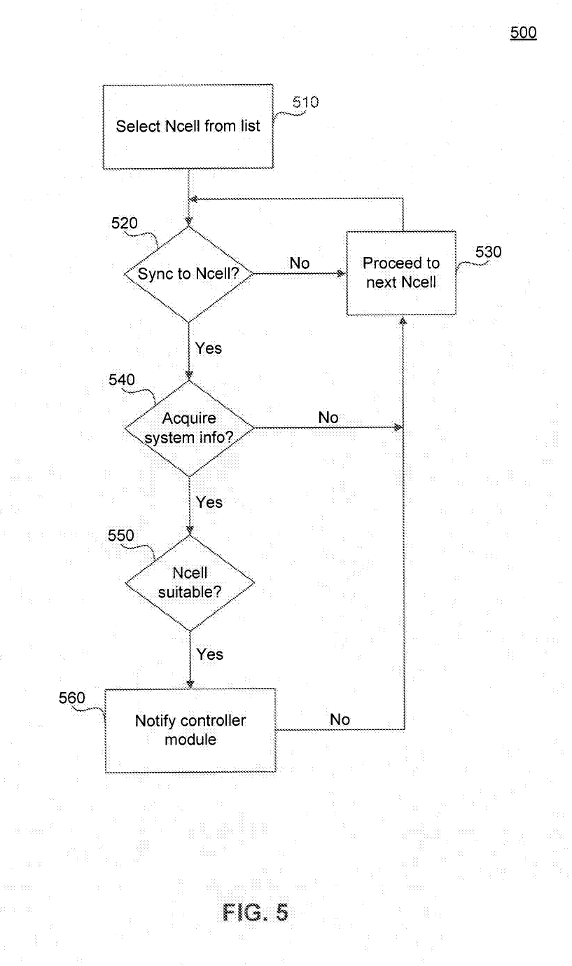

The exchange 430 will now be described in further detail with respect to FIG. 5. FIG. 5 illustrates a flowchart diagram of an exemplary exchange process that may occur during cell selection.

Initially, the third layer 404 selects an ncell from the ncell list (510) and reports the selection to the physical layer 402. The physical layer 402 attempts to sync to the selected ncell (520). If the sync fails (520—N), the physical layer 402 reports the failure to the third layer 404, which selects a new cell from the list (530). This new selection is reported to the physical layer 402. This repeats until an ncell is selected that allows for a successful sync.

Once the sync to the selected cell is successful (520—Y), the physical layer 402 attempts to acquire the system information of the selected ncell (540). If the system information acquisition fails (540—N), the physical layer 402 reports the failure to the third layer 404, which selects a new cell from the ncell list (530). Steps 520 and 540 repeat until system acquisition has succeeded.

Once the system information has been successfully acquired (540—Y), the physical layer reports the success and the system information to the third layer 404. The third layer 404 determines, based on the system information, whether the selected ncell is suitable (550). If the selected ncell is determined not to be suitable (550—N), the third layer 404 selects a new cell from the ncell list (530), and the method repeats until a suitable cell is found.

If, on the other hand, the third layer 404 determines the selected ncell to be suitable, the third layer 404 reports the connection success to the controller (560).

Referring back to FIG. 4, once the suitable ncell has been successfully connected to, the third layer 404 reports the connection success 432 to the controller 406, which reactivates (434) the service to the second SIM module 250. Once this process is complete, the controller module 230 continues with background paging monitoring, as described above.

### Exemplary Cell-Switching Triggering Method

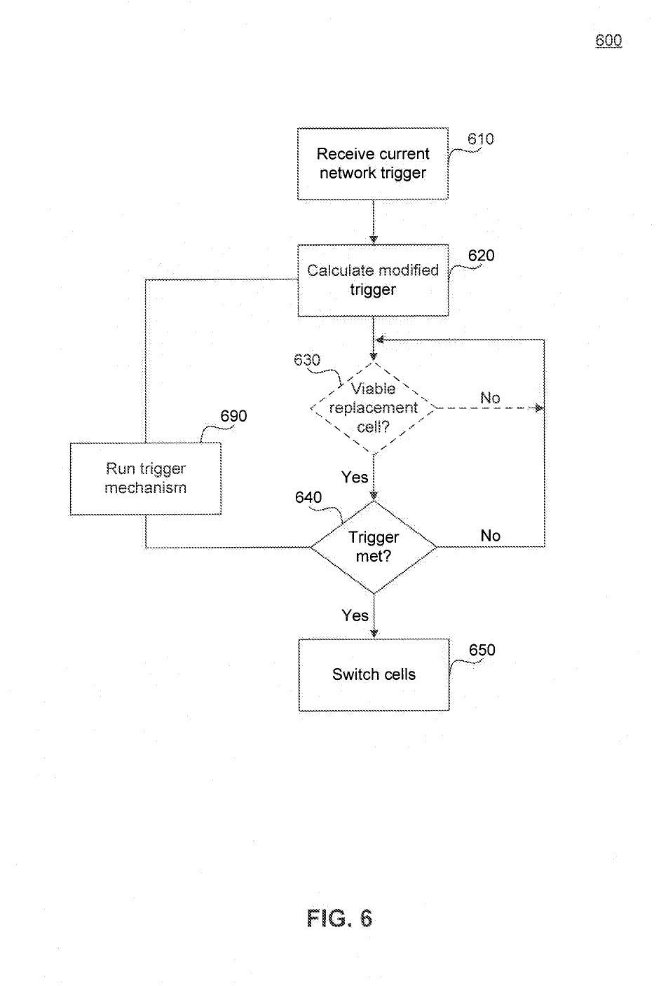

FIG. 6 illustrates a flowchart diagram of an exemplary cell switching triggering method 600. This method will be described below with reference to the components of the first SIM module 240 illustrated in FIG. 2B.

During an active period of the first SIM module, the trigger reception module 242 acquires a triggering mechanism and/or trigger threshold value from a serving base station (610). A triggering mechanism may be a method or algorithm for determining whether the trigger threshold value has been met, and the trigger threshold value may be associated with the mechanism and represent a need to switch serving cells. In an embodiment, the trigger reception module 242 acquires the triggering mechanism and/or trigger threshold value from memory within the wireless communication device 200 based on an RAT of the serving basestation. Once acquired, the trigger modification module 244 calculates a new mechanism and/or threshold value based on the originals (620). The modified triggering mechanism and modified trigger threshold value are stored in the trigger storage module 246 (an original mechanism is stored if the mechanism was not modified, and an original threshold value is stored if the threshold value was not modified).

In an embodiment, the first SIM module 240 seeks out and measures neighboring cells during active periods of the background paging monitoring. From these measurements, the first SIM module 240 determines whether there are any viable replacement cells among the neighboring cells (630). For example, the first SIM module 240 may determine that there is a viable replacement cell when a measured neighboring cell exceeds a receive signal power of the serving cell by a predetermined number of decibels.

In this embodiment, if a viable replacement cell is not found (630—N), the first SIM module 240 continues to seek out, measure, and analyze neighboring cells in order to discover a viable replacement cell (630). On the other hand, if a viable replacement cell is discovered (630—Y), the first SIM module 240 determines whether the stored trigger has been met based on the stored triggering mechanism (640).

Specifically, in the background, the link monitoring module 248 monitors performance of a current link to the serving cell and performs the triggering mechanism stored in the trigger storage module 246 (690). If the stored trigger has not been met (640—N), the first SIM module 240 again checks for the availability of the viable replacement cell (630) and then the trigger is re-checked (640). This repeats until the trigger has been met (640—Y).

Once the link monitoring module 248 determines that the stored trigger threshold value has been met using the stored triggering mechanism (640—Y), the link monitoring module 248 notifies the controller module 230, which initiates a switch of the serving cell (650) in the manner described above.

In an embodiment, the first SIM module 240 is unable to measure neighboring cells during its background paging monitoring active periods. In that circumstance, the first SIM module 240 begins monitoring whether the trigger has been met (640) immediately after the trigger mechanism begins (690).

Those skilled in the relevant art will recognize that the above method 600 may include any of the functionality of the wireless communication device 200 described above, and that the method should neither be limited by, nor construed to limit, the wireless communication device 200.

The embodiments of the disclosure have, at some instances, been described in terms of 2G and 3G cellular phone standards for convenience of discussion. However, the disclosure and teachings herein, are not limited 2G and 3G, any may be applied to other cellular phone standards, as will be understood by those skilled in the art.

### Exemplary Computer System Implementation

It will be apparent to persons skilled in the relevant art(s) that various elements and features of the present disclosure, as described herein, can be implemented in hardware using analog and/or digital circuits, in software, through the execution of instructions by one or more general purpose or special-purpose processors, or as a combination of hardware and software.

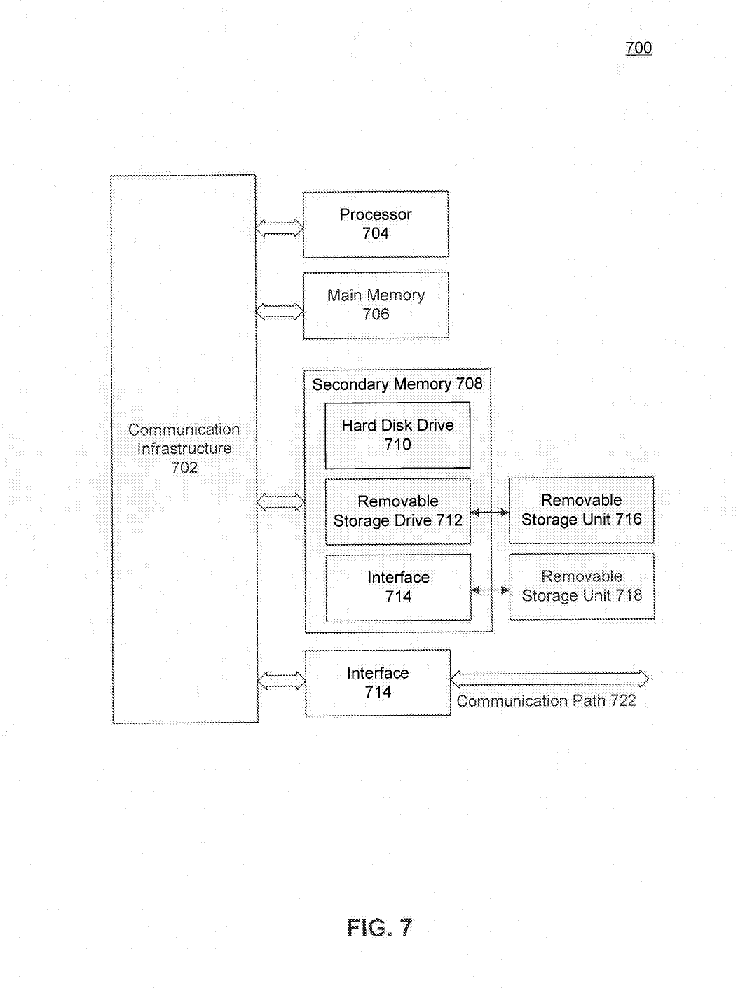

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. An example of such a computer system 700 is shown in FIG. 7. One or more of the modules depicted in the previous figures can be at least partially implemented on one or more distinct computer systems 700; including, for example, controller module 250, baseband processor 220, and trigger modification module 244, link monitoring module 248, and trigger reception module 242.

Computer system 700 includes one or more processors, such as processor 704. Processor 704 can be a special purpose or a general purpose digital signal processor. Processor 704 is connected to a communication infrastructure 702 (for example, a bus or network). Various software implementations are described in terms of this exemplary computer system. After reading this description, it will become apparent to a person skilled in the relevant art(s) how to implement the disclosure using other computer systems and/or computer architectures.

Computer system 700 also includes a main memory 706, preferably random access memory (RAM), and may also include a secondary memory 708. Secondary memory 708 may include, for example, a hard disk drive 710 and/or a removable storage drive 712, representing a floppy disk drive, a magnetic tape drive, an optical disk drive, or the like. Removable storage drive 712 reads from and/or writes to a removable storage unit 716 in a well-known manner. Removable storage unit 716 represents a floppy disk, magnetic tape, optical disk, or the like, which is read by and written to by removable storage drive 712. As will be appreciated by persons skilled in the relevant art(s), removable storage unit 716 includes a computer usable storage medium having stored therein computer software and/or data.

In alternative implementations, secondary memory 708 may include other similar means for allowing computer programs or other instructions to be loaded into computer system 700. Such means may include, for example, a removable storage unit 718 and an interface 714. Examples of such means may include a program cartridge and cartridge interface (such as that found in video game devices), a removable memory chip (such as an EPROM, or PROM) and associated socket, a thumb drive and USB port, and other removable storage units 718 and interfaces 714 which allow software and data to be transferred from removable storage unit 718 to computer system 700.

Computer system 700 may also include a communications interface 720. Communications interface 720 allows software and data to be transferred between computer system 700 and external devices. Examples of communications interface 720 may include a modem, a network interface (such as an Ethernet card), a communications port, a PCMCIA slot and card, etc. Software and data transferred via communications interface 720 are in the form of signals which may be electronic, electromagnetic, optical, or other signals capable of being received by communications interface 720. These signals are provided to communications interface 720 via a communications path 722. Communications path 722 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 716 and 718 or a hard disk installed in hard disk drive 710. These computer program products are means for providing software to computer system 700.

Computer programs (also called computer control logic) are stored in main memory 706 and/or secondary memory 708. Computer programs may also be received via communications interface 720. Such computer programs, when executed, enable the computer system 700 to implement the present disclosure as discussed herein. In particular, the computer programs, when executed, enable processor 704 to implement the processes of the present disclosure, such as any of the methods described herein. Accordingly, such computer programs represent controllers of the computer system 700. Where the disclosure is implemented using software, the software may be stored in a computer program product and loaded into computer system 700 using removable storage drive 712, interface 714, or communications interface 720.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### CONCLUSION

It is to be appreciated that the Detailed Description section, and not the Abstract section, is intended to be used to interpret the claims. The Abstract section may set forth one or more, but not all exemplary embodiments, and thus, is not intended to limit the disclosure and the appended claims in any way.

The invention has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus, the invention should not be limited by any of the above-described exemplary embodiments, but should be defined only in accordance with the following claims and their equivalents.

What is claimed is:

1. A wireless communication device, comprising:
a RF chain configured to receive wireless communication signals from a wireless communication environment;
a baseband processor configured to perform front-end processing of the received wireless communication signals;
a first SIM module configured to communicate with a first network, the first SIM module being designated for a first data type, the first SIM module including a trigger modification module configured to calculate at least one of a modified triggering mechanism and a modified trigger threshold value based on at least one of an original triggering mechanism and an original trigger threshold value;
a second SIM module configured to communicate with a second network, the second SIM module being designated for a second data type; and
a controller module configured to coordinate use of the RF chain and the baseband processor by the first SIM module and the second SIM module.

2. The wireless communication device of claim 1, wherein the original triggering mechanism defines an algorithm for determining whether the first SIM module should switch from a current serving cell to a new cell, and
wherein the original trigger threshold value defines a threshold value to be used within the original triggering mechanism.

3. The wireless communication device of claim 2, the first SIM module further including a trigger reception module configured to receive the original trigger mechanism and the original trigger threshold value from the current serving cell.

4. The wireless communication device of claim 2, the first SIM module further including a trigger reception module configured to determine a radio access technology of the current serving cell, and to retrieve the original triggering mechanism and the original trigger threshold value from a memory based on the determined radio access technology.

5. The wireless communication device of claim 2, wherein the trigger modification module is configured to calculate the at least one of the modified triggering mechanism and the modified trigger threshold value so as to trigger a switch from the current serving cell to the new cell at a modified time that is earlier than an original time at which the switch would have occurred based on the original triggering mechanism and the original trigger threshold value.

6. The wireless communication device of claim 5, wherein the modified time is within a balanced time range that balances reducing missed calls, maximizing battery life, and minimizing interruptions to the second SIM module service.

7. The wireless communication device of claim 6, wherein
for a 3G radio access technology, the trigger modification module is configured to set the modified trigger threshold value to a predetermined time period, and
for a 2G radio access technology, the trigger modification module is configured to calculate the modified trigger threshold value equal to a rounded midpoint between an initial threshold value and the original trigger threshold value.

8. A wireless communication device, comprising:
a first SIM module configured to communicate with a first wireless network, the first SIM module including:
a trigger modification module configured to calculate at least one of a modified trigger threshold value and a modified triggering mechanism; and
a link monitoring module configured to perform the modified triggering mechanism in order to determine whether a current serving cell has been lost, the link monitoring module declaring the current serving cell as lost when the modified trigger threshold value has been met;
a second SIM module configured to communicate with a second wireless network; and
a controller module configured to coordinate active signal reception between the first SIM module and the second SIM module.

9. The wireless communication device of claim 8, wherein the first SIM module is designated for circuit-switched data.

10. The wireless communication device of claim 9, wherein the second SIM module is designated for packet-switched data.

11. The wireless communication device of claim 8, wherein the controller module is configured to periodically interrupt service to the second SIM module, and
wherein the first SIM module is configured to decode a paging block during the periodic interrupts to the service of the second SIM module.

12. The wireless communication device of claim 8, wherein the link monitoring module is configured to perform the modified triggering mechanism during active periods of the first SIM module.

13. The wireless communication device of claim 11, wherein the first SIM module is configured to measure neighboring cells during the periodic interrupts of the second SIM module.

14. The wireless communication device of claim 13, wherein the link monitoring module is configured to only determine whether the modified trigger threshold value has been met after the first SIM module discovers a neighboring cell that has a signal strength that is a predetermined threshold stronger than the current serving cell.

15. A method for switching serving cells in a wireless communication device having a first SIM module for communicating on a first network and a second SIM module for communicating on a second network, the first SIM module and the second SIM module serviced by a single baseband processor and RF chain, the method comprising:
temporarily suspending cellular service to the second SIM module;
while the second SIM module is temporarily suspended:
setting the first SIM module to an active state during the suspended cellular service to the second SIM module; and
receiving an original triggering mechanism and an original trigger threshold value by the first SIM module;
calculating at least one of a modified triggering mechanism and a modified trigger threshold value based on the original triggering mechanism and the original trigger threshold value, respectively; and
determining whether a current serving cell of the first SIM module has been lost based on the at least one of the modified triggering mechanism and the modified trigger threshold value.

16. The method of claim 15, wherein the original triggering mechanism and the original trigger threshold value are received from the current serving cell.

17. The method of claim 15, wherein the original triggering mechanism and the original trigger threshold value are retrieved from a memory based on a radio access technology of the current serving cell.

18. The method of claim 15, wherein the calculating includes calculating the at least one of the modified triggering mechanism and the modified trigger threshold value so as to identify the current serving cell as lost at an earlier time than would have been identified by the original triggering mechanism and the original trigger threshold value.

19. The method of claim 15, further comprising measuring neighboring cells while the second SIM module is temporarily suspended.

20. The method of claim 19, wherein the determining is performed only after a neighboring cell is measured to have a signal strength that is a threshold value stronger than a signal strength of the current serving cell.
